(19) United States
(12) Patent Application Publication
(10) Pub. No.: US 2025/0384307 A1
(43) Pub. Date: Dec. 18, 2025

(54) SYSTEMS AND METHODS RELATED TO EFFICIENT KNOWLEDGE BASE QUERIES FOR ENHANCED CUSTOMER DIALOG MANAGEMENT IN A CONTACT CENTER

(71) Applicant: GENESYS CLOUD SERVICES, INC., MENLO PARK, CA (US)

(72) Inventors: RAMASUBRAMANIAN SUNDARAM, HYDERABAD (IN); BASIL GEORGE, HYDERABAD (IN); PAVAN BUDUGUPPA, HYDERABAD (IN); SYED AREEB AHMAD, HYDERABAD (IN); SUDHANSHU SHEKHAR, HYDERABAD (IN)

(73) Assignee: GENESYS CLOUD SERVICES, INC., MENLO PARK, CA (US)

(21) Appl. No.: 18/746,230

(22) Filed: Jun. 18, 2024

(51) Int. Cl. G06N 5/022; G06F 40/40; G06Q 30/015

(52) U.S. Cl. CPC G06N 5/022; G06F 40/40; G06Q 30/015

(57) ABSTRACT

A method in a contact center for generating an action classifier model and use thereof in selectively initiating turn set queries of a knowledge base to assist agents in real time during ongoing conversations with customers. The method includes: generating an action classifier model; receiving classification data that classifies a first plurality of the customer actions found in training samples as belonging to a first action category for which a knowledge base search is deemed needed, and a second plurality of the customer actions as belonging to a second action category for which a knowledge base search is deemed not needed; and using the action classifier model and the received classification data to perform a query filtering routine for selectively initiating a turn set query for a present turn set occurring in an ongoing conversation between an agent and customer.

### BACKGROUND

The present invention generally relates to customer relations services and customer relations management via contact centers and associated cloud-based systems. More particularly, but not by way of limitation, the present invention pertains to systems and methods relating to more efficient knowledge base management, including how turn set queries are submitted thereto, for enhancing dialog management relative to ongoing conversations occurring between contact center agents and customers.

### BRIEF DESCRIPTION OF THE INVENTION

The present invention includes a method that may be used by a contact center for generating an action classifier model and use thereof in selectively initiating turn set queries of a knowledge base to assist agents in real time during ongoing conversations with customers. The method may include generating, via an automated modeling process, an action classifier model. The method may include receiving classification data that classifies: a first plurality of the customer actions found in training samples as belonging to a first action category for which a knowledge base search is deemed needed; and a second plurality of the customer actions as belonging to a second action category for which a knowledge base search is deemed not needed. The method may include using the action classifier model and the received classification data to perform a query filtering routine in relation to a present turn set occurring in an ongoing conversation between an agent and customer. The query filtering routine may include selectively initiating a turn set query of a knowledge base in relation to the present turn set based on whether a customer action for the present turn set is determined by the action classifier model to belong to the first action category type or the second action category type.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is a diagram illustrating an embodiment of the logical architecture for a conversation orchestration engine.

FIG. 4 is a diagram illustrating an embodiment of a system architecture for a dialog engine;

FIG. 5 is a diagram illustrating an embodiment of a system architecture for a dialog engine;

FIG. 6 is a flowchart of supporting an agent of a contact center system engaged in a dialog with a user;

FIG. 7 is a schematic representation of a machine learning model in accordance with exemplary operation of embodiments of the present invention;

FIG. 8 is a schematic representation of a conventional knowledge management system;

FIG. 9 is a schematic representation of a system of generating training samples for training a model in accordance with an exemplary embodiment;

FIG. 10 is a schematic representation of a knowledge management system according to an embodiment of the present application;

FIG. 11 is an exemplary method of selectively initiating turn set queries to a knowledge base according to the present invention;

FIG. 12 is an exemplary method for generating an action classifier model according to the present invention; and

FIG. 13 is an exemplary method for performing a query filtering routine with the action classifier model according to the present invention.

### DETAILED DESCRIPTION

For the purpose of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as an apparatus, method, or computer program product. Example embodiments, thus, may take the form of a hardware embodiment, a software embodiment, or combination thereof.

### Computing Device

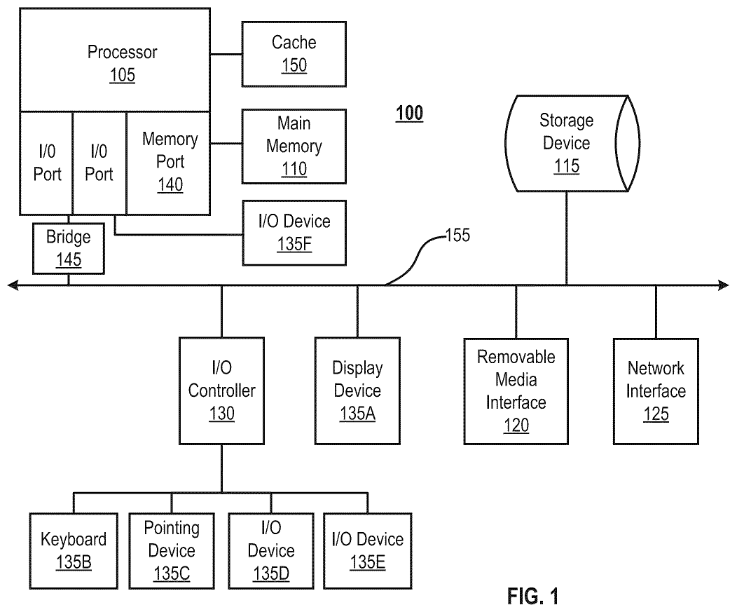

The present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced.

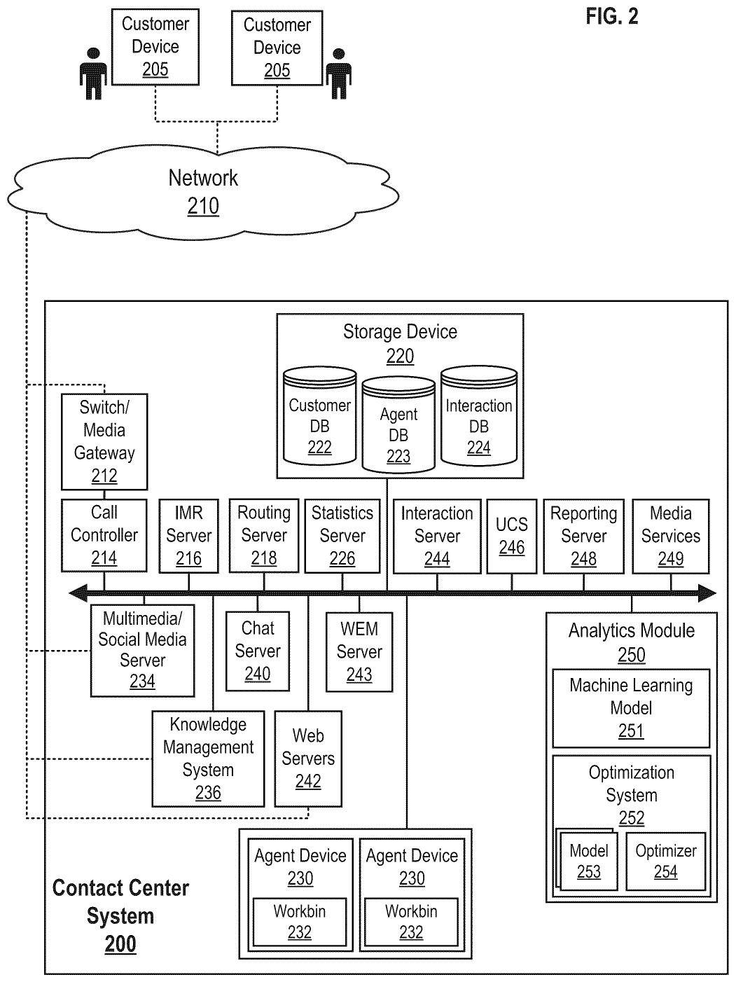

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as, for example, via voice (e.g., telephone calls or voice over IP or VolP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “chatbots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment such as, for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management system 236; chat server 240; web servers 242; interaction server 244; universal contact server (or “UCS”) 246; reporting server 248; media services server 249; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, etc.) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VolP calls), emails, voicemails, video, chat, screen-sharing, text messages, social media messages, WebRTC calls, etc. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, etc.) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VoIP calls, etc. The call controller 214 may include computer-telephone integration (CTI) software for interfacing with the switch/media gateway and other components. The call controller 214 may extract data about an incoming interaction, such as the customer's telephone number, IP address, or email address, and then communicate these with other contact center components in processing the interaction.

The interactive media response (IMR) server 216 enables self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices—represented generally by the storage device 220—for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VoIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management system 236 may be configured to facilitate interactions between customers and a knowledge base. In general, the knowledge management system 236 may be a computer system capable of receiving questions or queries and providing answers in response, for example, by matching queries with entries in the knowledge base. The knowledge management system 236 may include an artificially intelligent computer system capable of answering questions posed in natural language by retrieving information from information sources such as encyclopedias, dictionaries, newswire articles, literary works, or other documents submitted to the knowledge management system 236 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, etc. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, etc.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more artificial intelligence-based models, including machine learning models, such as neural networks, deep learning models as well as other types as described herein. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 252 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

### Conversation Orchestration Engine

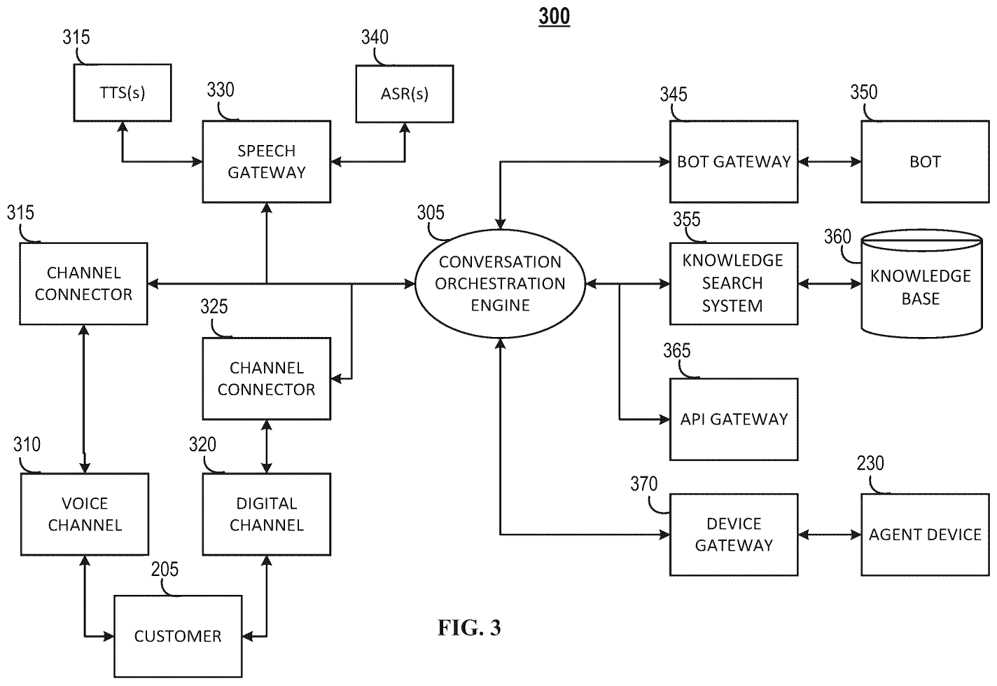

FIG. 3 is a diagram illustrating an embodiment of the logical architecture for a conversation orchestration engine system, indicated generally at 300. In an embodiment, the system 300 may be employed in a contact center system 100 (FIG. 1). Components of the conversation orchestration engine system 300 may include a Conversation Orchestration Engine 305, a voice channel 310, a voice channel connector 315, a digital channel 320, a digital channel connector 325, a speech gateway 330, a real time transcription (TTS) service 335, a speech to text (ASR) service 340, a bot gateway 345, a bot 350, a knowledge search system 355, a knowledge base 360, an API gateway 365, a device gateway 370, and an agent device 230.

A customer 205 may communicate with the contact center system 100 in which the conversation orchestration engine system 300 is implemented using communication channels such as the voice channel 310 and the digital (or video) channel 320. Other channels, such as text channels, web chat channels and multimedia channels may similarly be supported and enable communication with parties external to the contact center. The channel connectors 315, 325 handle inbound and outbound information flow between the conversation orchestration engine 305 and the channels 310, 320. The channel connectors 315, 325 may be platform specific or common across multiple platforms (e.g., Hub for Apple Business Chat, Facebook).

The speech gateway 330 provides access to the TTS service 335 and the ASR service 340, so that speech data may be converted to text and vice versa. Other components of the contact center which employ text-based inputs and outputs may therefore use audio data containing speech as an input or may have their outputs converted to a recognizable speech audio signal. In an embodiment, TTS service 335 for voice channels may be third party.

The bot gateway 345 provides a connection for one or more bots 350, allowing them to interact with the orchestration engine 305. Bot knowledge (vocabulary and action set) comprises a domain. The elements of a domain further comprise entities, slots, intent, utterances, behavioral trees, context, and channel specific implementation. The details of these are further described below.

The knowledge base 360 provides content in response to queries. The knowledge base may be a third-party knowledge base or be an organic solution. An intermediary service (the knowledge search system 305) is used to allow for dialog context-based search to be federated over knowledge sources that are registered in a gateway.

The conversation orchestration engine 305 acts as a conduit which orchestrates actions throughout the contact center in response to conversation flows. The Conversation Orchestration Engine 305 comprises platform specific services and common services which may also incorporate a dialog engine as part of a native conversation AI capability. The Conversation Orchestration Engine may also use third party systems providing voice-and text-based conversation interfaces like Google's Dialogflow or Amazon Lex. It acts as a conduit orchestrating all event flow. The Conversation Orchestration Engine 355 is structured dependent on platform and target deployment model (cloud, premises, hybrid). Having this engine provides for the ability to maintain universal context and arbitrate action at almost any level.

The agent device 230 (FIG. 2) comprises an interface which permits a contact center agent to participate in an interaction or conversation with a customer 205, as well as permitting interaction with other agents, supervisors, and automated entities of the contact center such as the bot 350. An intermediary service (the Device Gateway 370) handles pushing of information to the Agent's device 230 and serves queries from the device to the conversation orchestration engine 305.

The API Gateway 365 enables the conversation orchestration engine 305 to interact with a wide range of other systems and services via application program interfaces, including internal and external systems and services.

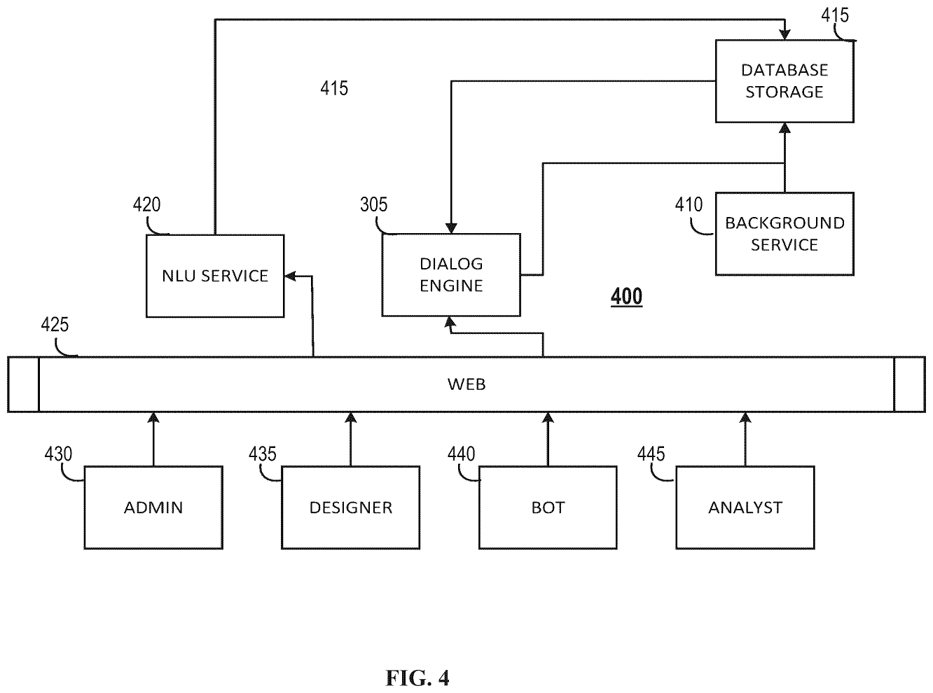

FIG. 4 is a diagram illustrating an embodiment of a system architecture for a dialog engine, indicated generally at 400. In an embodiment, the system 400 may be used in a hybrid micro-service architecture. Components of the dialog engine system 400 may include a dialog engine 405, a background database service 410, a storage database 415, a natural language understanding (NLU) service 420, internet (or web) 425, an admin program 430, a designer program 435, a bot 440, and an analyst program 445. The admin program 430 enables an administrator to control user management within the dialog engine 405 through a user API via the web 425. The designer program 435 enables a system designer to create bot applications and bot models through APIs connected to the web 425. The NLU service 420 may be an artificial intelligence service which is capable of receiving and interpreting naturally spoken speech data according to a trained language model. The NLU model is trained and then uploaded with the bot model to a storage database 415. The bot 440 inputs dialog through an API. There may be an arbitrary number of bot instances, such as, for example, one bot per dialog session with a user. The dialog engine 405 downloads the bot model from the storage database 415 and can then process a dialog behavior tree as described in greater detail below. The processing session is uploaded to the storage database 415. The web 425 comprises a background service 410 which trains the models. The trained modes are provided to the storage database 415 for use by the dialog engine 405. The analyst program 445 requests reports for bot performance and tuning. The dialog engine system 400 is implemented as a component within the conversation orchestration engine 305 (FIG. 3).

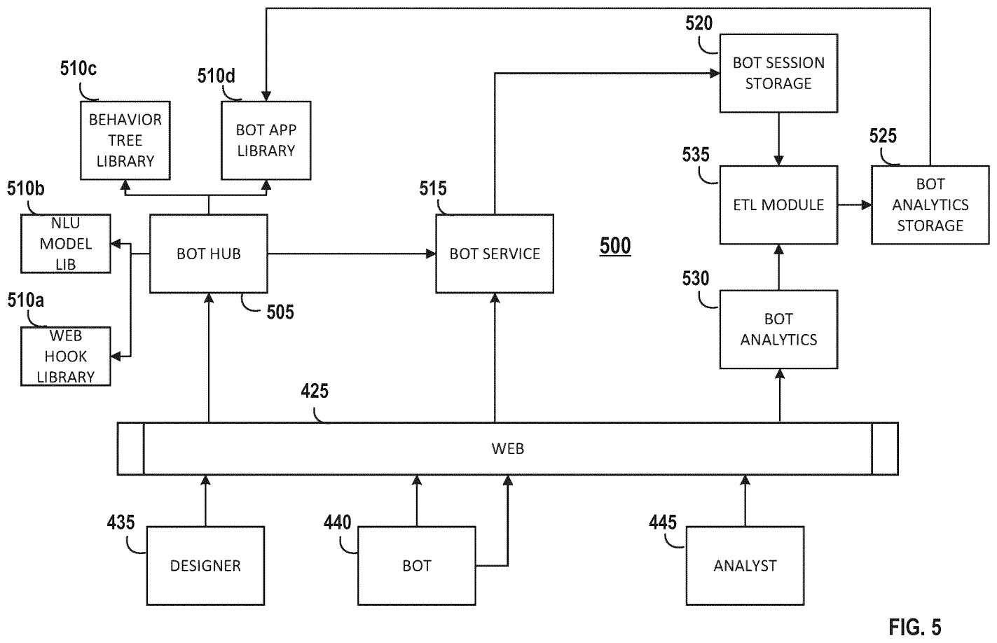

FIG. 5 is a diagram illustrating an embodiment of a system architecture for a dialog engine, indicated generally at 500. In an embodiment, the system 500 may be used in a cloud native micro-service architecture. Components of the dialog engine 500 comprise: a designer program 435, a bot 440, an analyst program 445, the web 425, a bot hub 505 that links to a plurality of libraries 510a-d, a bot service 515, a bot session storage 520, a bot analytics storage 525, a bot analytics module 530, and an extract, transform and load (ETL) module 535.

The splitting of the dialog engine 505 into three services within the system 500 (e.g., the bot hub 505, bot service 515, and bot analytics module 530) vertically, allows each service to be deployed, upgraded, and scaled individually to meet its own requirements. For example, the bot service 515 might require fast access to its session storage. Memcached, which is a general-purpose distributed memory caching system, could be placed on top of database storage in order to speed up data access by caching data and objects in RAM to reduce the number of times the database storage must be read. In addition, bot service 515 often requires rapid scalability (up and down) in response to a load in real-time. Conversely, bot analytics 530 may not require real-time processing and could be run in a batched manner. Bot hub 505 requires being highly secure, transaction and well version controlled. It may also require access globally. The bot hub 505 serves as the frontend and the back end for bot modeling. Users are able to pull, save, and publish all bot design artifacts and reuse them across projects from the libraries 510a-d. During deployment, the bot service 515 may also pull domain files and trained NLU models from the bot hub 505. The libraries 510a-d comprise a web hook library 510a, a natural language understanding (NLU) model library 510b, a behavior tree library 510c, and a bot library 510d.

The bot service 515 provides live bot services in real-time. The bot service 515 is capable of integration with omni-channel multimedia, such as voice, messenger services (e.g., Facebook Messenger, Slack, Skype), social media (Twitter). Real-time monitoring is also provided, allowing agents to “barge-in”.

The bot analytics module 530 provides bot analytics that give insights into the operation of the contact center by mining past chat transcripts from the bot session storage 520 using the ETL Module 535. Feedback from the bot analytics module 530, such as fail to be interpreted user utterances, unexpected user intents, bad business practices, bad actions, bad webhook requests, etc., can be used to further improve bot modeling and stored 525 for use by other components, such as the bot app library 510d. The bots implement a behavior tree form of operation to control, direct or manage conversations taking place with customers of the contact center.

Generally, as previously mentioned, bot knowledge (e.g., vocabulary and action set) comprises a domain. The elements of a domain further comprise entities, slots, intent, utterances, behavioral trees, context, and channel specific implementation.

An entity may be another name for a data type. Entities may be built in, like strings and dates. They may be defined as: “Plugin Name: de.entities.BuiltIn”. This string declares an entity called ‘Name’ is implemented by a particular plugin class. Entities may be pre-registered to be made accessible. Paths may also be specified for custom entities. A slot comprises an instance of an entity. Slots may have a name, an entity, and may have prompts to use when slot filling. A prompt is an example of an utterance generated by the engine and may be defined with templates. An intent is a semantic label assigned to an utterance. Intent may also include a display_name which can be used for confirmation behaviors. Intents also comprise labels for natural language text. An utterance, or prompt, comprises a message generated by a bot. An utterance may be defined using templates with parameters which are filled from context, or passed in explicitly when the utterance is selected. An utterance may include alternative templates, allowing for variation in a dialog. Not all templates may have the same parameters. Variations may also be preferred, depending on the amount of information in the context.

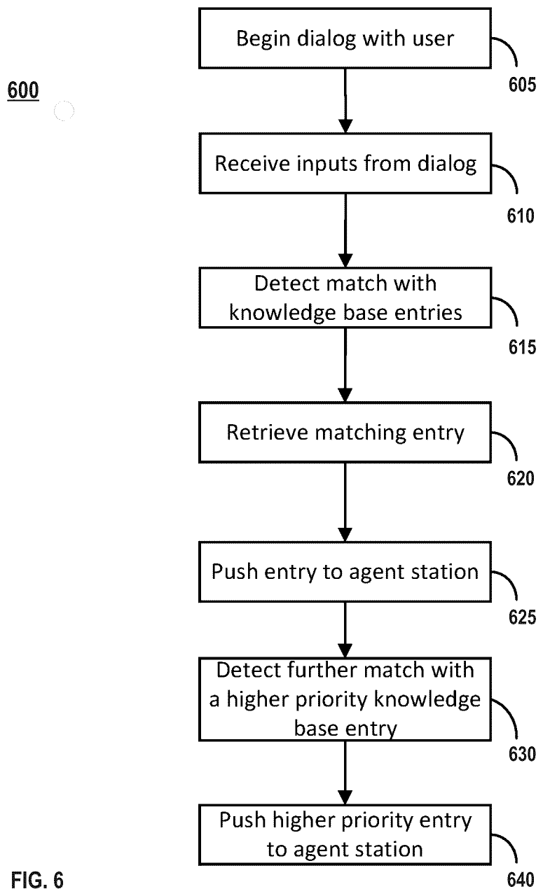

FIG. 6 is a flowchart 600 of a method of supporting an agent of a contact center system engaged in a dialog with a user. In step 605, a dialog is started between a user of the contact center and a contact center agent. The system receives inputs from the dialog, step 610, and continually interprets the inputs by matching them against a knowledge base. When a match is detected with an entry in the knowledge base, step 615, this indicates that the agent may be assisted by the knowledge base entry or article. Therefore, in step 620 the matching entry is retrieved, and in step 625 the entry is pushed to the agent workstation. It will be appreciated that depending on how the system is implemented and the number and relevance of the matches detected, as well as the business rules according to which knowledge base entries are to be provided to an agent (such as for example if there is a current promotion or campaign prioritizing that the conversation be driven in a specific direction), more than one knowledge base entry can be provided to the agent station. The knowledge base entries may be presented in a concise form to allow the agent to readily perceive the content and relevance of each, such as by showing the agent a list of knowledge base titles and perhaps a snippet of the entry from which the agent can understand the context in which it has been selected for presentation.

As the conversation continues, the system continues to look for matches with knowledge base entries based on both new inputs and the aggregation of inputs in context. In step 630, the system detects a further match with a higher priority knowledge base entry (or entries). The higher priority entry is pushed to the agent station in step 635. This higher priority may be determined from a priority rating built into the knowledge base or may be determined dynamically with priorities changing according to the progress of the conversation and the specifics of the customer. As an example, a priority of an already-presented knowledge base entry may be reduced once the agent has accessed it or dismissed it (both indicating that the agent has no further use for the entry. Priorities may be ranked according to an expected progression of a typical interaction, e.g. towards the start of a conversation higher priority may be given to more general information explaining various offers, while later in the conversation higher priority may be given to entries that assist in closing a sale. As another example, in a PC manufacturer's technical support contact center, a suggestion to check for an update to a specific device driver might be prioritized at a very low level during the initial exchanges, but its priority might be progressively increased as the conversation develops and the earlier diagnostic steps make it more likely that the device driver is the cause of the problem.

### Machine Learning Models

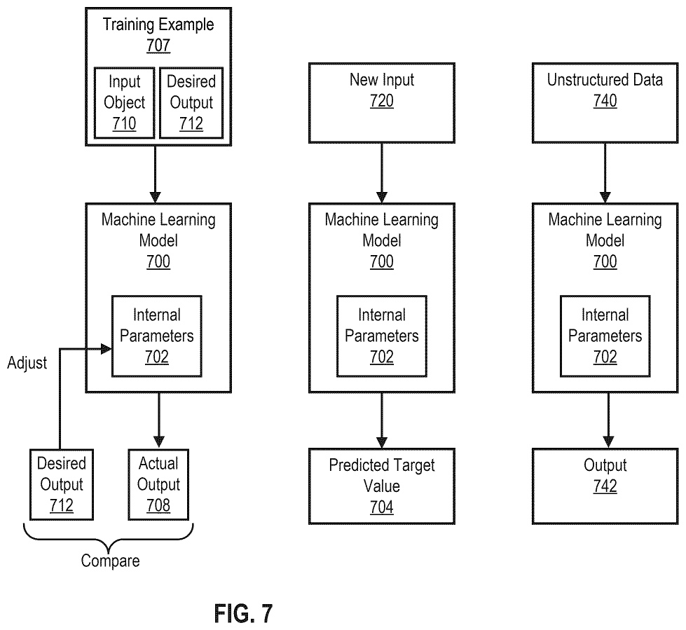

FIG. 7 illustrates an exemplary machine learning model 700, which may be included in one or more of the embodiments of the present invention. The machine learning model 700 may be a component, module, computer program, system, or algorithm. As described below, some embodiments herein use machine learning for providing predictive analytics for application in a contact center. Machine learning model 700 may be used as the model to power those embodiments. Machine learning model 700 is trained with training data samples 706, which may include an input object 710 and a desired output value 712. For example, the input object 710 and desired object value 712 may be tensors. A tensor is a matrix of n dimensions where n may be any of 0 (a constant), 1 (an array), 2 (a 2D matrix), 3, 4, or more.

The machine learning model 700 has internal parameters that determine its decision boundary and that determine the output that the machine learning model 700 produces. After each training iteration, which includes inputting the input object 710 of a training data sample into the machine learning model 700, the actual output 708 of the machine learning model 700 for the input object 710 is compared to the desired output value 712. One or more internal parameters 702 of the machine learning model 700 may be adjusted such that, upon running the machine learning model 700 with the new parameters, the produced output 708 will be closer to the desired output value 712. If the produced output 708 was already identical to the desired output value 712, then the internal parameters 702 of the machine learning model 700 may be adjusted to reinforce and strengthen those parameters that caused the correct output and reduce and weaken parameters that tended to move away from the correct output.

The machine learning model 700 output may be, for example, a numerical value in the case of regression or an identifier of a category in the case of classifier. A machine learning model trained to perform regression may be referred to as a regression model and a machine learning model trained to perform classification may be referred to as a classifier. The aspects of the input object that may be considered by the machine learning model 700 in making its decision may be referred to as features. After machine learning model 700 has been trained, a new, unseen input object 720 may be provided as input to the model 700. The machine learning model 700 then produces an output representing a predicted target value 704 for the new input object 720, based on its internal parameters 702 learned from training.

The machine learning model 700 may be, for example, a neural network, support vector machine (SVM), Bayesian network, logistic regression, logistic classification, decision tree, ensemble classifier, or other machine learning model. Machine learning model 700 may be supervised or unsupervised. In the unsupervised case, the machine learning model 700 may identify patterns in unstructured data 740 without training data samples 707. Unstructured data 740 is, for example, raw data upon which inference processes are desired to be performed. An unsupervised machine learning model may generate output 742 that includes data identifying structure or patterns.

The neural network may consist of a plurality of neural network nodes, where each node includes input values, a set of weights, and an activation function. The neural network node may calculate the activation function on the input values to produce an output value. The activation function may be a non-linear function computed on the weighted sum of the input values plus an optional constant. In some embodiments, the activation function is logistic, sigmoid, or a hyperbolic tangent function. Neural network nodes may be connected to each other such that the output of one node is the input of another node. Moreover, neural network nodes may be organized into layers, each layer including one or more nodes. An input layer may include the inputs to the neural network and an output layer may include the output of the neural network. A neural network may be trained and update its internal parameters, which include the weights of each neural network node, by using backpropagation.

In some embodiments, a convolutional neural network (CNN) may be used. A convolutional neural network is a type of neural network and machine learning model. A convolutional neural network may include one or more convolutional filters, also known as kernels, that operate on the outputs of the neural network layer that precede it and produce an output to be consumed by the neural network layer subsequent to it. A convolutional filter may have a window in which it operates. The window may be spatially local. A node of the preceding layer may be connected to a node in the current layer if the node of the preceding layer is within the window. If it is not within the window, then it is not connected. A convolutional neural network is one kind of locally connected neural network, which is a neural network where neural network nodes are connected to nodes of a preceding layer that are within a spatially local area. Moreover, a convolutional neural network is one kind of sparsely connected neural network, which is a neural network where most of the nodes of each hidden layer are connected to fewer than half of the nodes in the subsequent layer. In other embodiments, a recurrent neural network (RNN) may be used. A recurrent neural network is another type of neural network and machine learning model. A recurrent neural network includes at least one back loop, where the output of at least one neural network node is input into a neural network node of a prior layer. The recurrent neural network maintains state between iterations, such as in the form of a tensor. The state is updated at each iteration, and the state tensor is passed as input to the recurrent neural network at the new iteration. In still other embodiments, the recurrent neural network is a long short-term memory (LSTM) neural network. In some embodiments, the recurrent neural network is a bi-directional LSTM neural network. A feed forward neural network is another type of a neural network and has no back loops. In some embodiments, a feed forward neural network may be densely connected, meaning that most of the neural network nodes in each layer are connected to most of the neural network nodes in the subsequent layer. In some embodiments, the feed forward neural network is a fully-connected neural network, where each of the neural network nodes is connected to each neural network node in the subsequent layer. A gated graph sequence neural network (GGSNN) is a type of neural network that may be used in some embodiments. In a GGSNN, the input data is a graph, comprising nodes and edges between the nodes, and the neural network outputs a graph. The graph may be directed or undirected. A propagation step is performed to compute node representations for each node, where node representations may be based on features of the node. An output model maps from node representations and corresponding labels to an output for each node. The output model is defined per node and is a differentiable function that maps to an output. Further, embodiments may include neural networks of different types or the same type that are linked together into a sequential or parallel series of neural networks, where subsequent neural networks accept as input the output of one or more preceding neural networks. The combination of multiple neural networks may be trained from end-to-end using backpropagation from the last neural network through the first neural network. As stated, the machine learning model 251 may also be configured as a deep learning model. The deep learning model is a type of machine learning based on neural networks in which multiple layers of processing are used to extract progressively higher level features from data. Deep learning models are generally more adept at unsupervised learning.

In certain embodiments, the deep learning model may include transformer architecture. As will be appreciated, transformer architecture follows an encoder-decoder structure but does not rely on recurrence and convolutions to generate an output. Transformer architecture represents an evolution on the encoder-decoder architecture by introducing novel attention mechanisms and parallel processing capabilities. This type of architecture is behind the most recent wave in Generative AI powering models like ChatGPT. All transformers have the same primary components, including: tokenizers, which convert text into tokens; a single embedding layer, which converts tokens and positions of the tokens into vector representations; transformer layers, which carry out repeated transformations on the vector representations, extracting more and more linguistic information (these consist of alternating attention and feedforward layers); and (optionally) an un-embedding layer, which converts the final vector representations back to a probability distribution over the tokens. Transformer layers can be one of two types, encoder and decoder. In the original form, both types of layers were used, while later models included only one type of them. BERT is an example of an encoder-only model, while GPT are decoder-only models. The input text is parsed into tokens by a tokenizer, most often a byte pair encoding tokenizer, and each token is converted into a vector via looking up from a word embedding table. Then, positional information of the token is added to the word embedding. Like earlier seq2seq models, the original transformer model used an encoder-decoder architecture. The encoder consists of encoding layers that process the input tokens iteratively one layer after another, while the decoder consists of decoding layers that iteratively process the encoder's output as well as the decoder output's tokens so far. The function of each encoder layer is to generate contextualized token representations, where each representation corresponds to a token that “mixes” information from other input tokens via self-attention mechanism. Each decoder layer contains two attention sublayers: (1) cross-attention for incorporating the output of encoder (contextualized input token representations), and (2) self-attention for “mixing” information among the input tokens to the decoder (i.e., the tokens generated so far during inference time). Both the encoder and decoder layers have a feed-forward neural network for additional processing of the outputs and contain residual connections and layer normalization steps.

### Efficient Knowledge Base Queries for Improved Customer Dialog Management

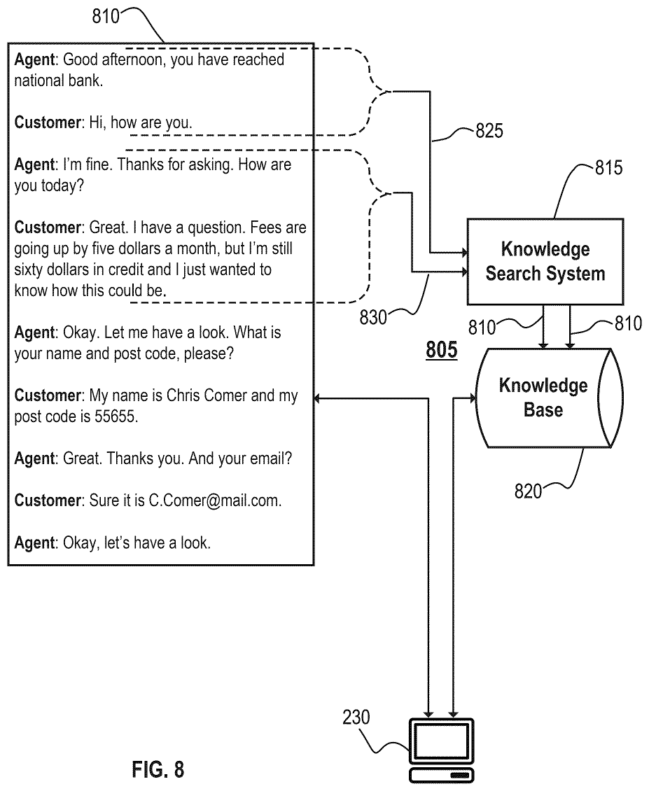

Turning now to FIGS. 8-13, functionality of a knowledge management system will now be described in accordance with embodiments of the present invention. Before proceeding with this, though, background as to how a knowledge base is managed in a conventional contact center function will be discussed. As part of this discussion, certain problematic areas with conventional systems will be highlighted that, as will be seen, the present invention alleviates.

The interactions that occur between customers and customer service agents (or simply “agents”) are key to the delivery of services by contact centers. The manner in which these interactions are conducted provide valuable insights into customer needs and preferences as well as agent performance. The natural language conversations that occur between customers and agents during these interactions-either via voice or text channels-provide a rich source of data for gauging the operational performance of a contact center.

During such conversations, the customer often has queries about products or services. Such questions can be answered by the agent, articles or documents retrieved from a knowledge base, or a combination thereof. With the advent of AI, there are systems that monitor aspects of conversation to assist agents by retrieving information when helpful. To reduce the load on these systems, it would enhance efficiency if the knowledge base is searched in relation to only those queries having a high probability of success, i.e., those likely to return a document from the knowledge base that is useful in resolving the customer's query. As will be seen, in this disclosure, systems and methods are proposed for leveraging generative AI to analyze conversations in real time to determine whether querying a knowledge base is an efficient use of resources.

When an agent is having a conversation with a customer on a particular topic, the agent has various sources of information with which to resolve customer requests and answer customer queries. For one, the agent can rely on what they already know on the topic of the query. Further, there may be transactional information (like asking for policy number, date of birth, etc.) that can help the agent assist the customer. Additionally, as described in relation to the figures above, knowledge base can be searched to retrieve information that answers or resolves the customer's inquiries. Typically, an ongoing customer-agent conversation moves between such sources of information based on what stage the conversation is in. In general, consulting a knowledge base includes a knowledge search system posing a search query to the knowledge base, which may be done manually by the agent or via automation based on content derived from the conversation. For the knowledge base to be used effectively, the search query posed to it must be precise in regard to the information being sought. This avoids overloading the knowledge search system. It also reduces the cognitive load placed on the agent, as the agent is not bombarded with irrelevant search results.

With reference now to FIG. 8, a conventional knowledge management system 805 is depicted that may be employed to assist an agent during interactions with customers. The agent may be conducting the interaction, which may include a real time voice or text conversation, via an agent device 230. In the example, shown the real time conversation is depicted by conversation text 810, which includes conversational statements or turns by both the agent and the customer. As further indicated in the provided figure, the knowledge management system 805 includes a knowledge search system 815 and knowledge base 820. As will be appreciated, the knowledge search system 815 fashions queries that are then posed to the knowledge base 820 for retrieving relevant information that can then be used by the agent to assist the customer in real time.

As the conversation occurs, each successive pair of turns (or “turn pair”) in the conversation text 810 is sent to the knowledge search system 815 and used thereby to formulate a search query, which is then posed to the knowledge base 820 for retrieving relevant information or documents therefrom. For example, using the formulated search query, a determination may be made as to whether the knowledge base 820 has matching documents and/or whether such documents are sufficiently relevant that they should be retrieved and provided to the agent for use in assisting the customer. As an example, the documents within the knowledge base may be analyzed in regard to a relevance to language used in the turns and, if the analysis results in a relevancy that exceeds some predefined threshold, the search results, i.e., the document may be retrieved and delivered to the agent. The retrieved document may be shown to the agent via a display window that is incorporated into a user interface of an agent device 230.

In the example shown, an initial turn pair 825 is transmitted to the knowledge search system 815, which then formulates a search related thereto. Once formulated, the search is passed along to the knowledge base 820 for determining if there are relevant documents and whether those should be retrieved for providing to the agent. It will be appreciated that these steps occur in real time so any relevant documents can be returned to the agent so to assist in the interaction as it is occurring with the customer. As will be further appreciated, the steps are then repeated for the next turn pair 830, with the process continuing over the course of the conversation for each successively occurring turn pair.

This mode of operation—which includes formulating searches in relation to new speaking turn or turn pair and analyzing the results as to whether any documents should be retrieved for showing to the agent—results in a high computation load for the knowledge base system. Further, it inefficiently adds to the cognitive load on the agent, as it inevitably leads to the agent being distracted by too many search results. Even if search results are irrelevant, it still typically requires at least a cursory review by the agent to determine that the results can be ignored. With agents already being stressed with multitasking different types of work and handling concurrent interactions, inefficiencies of this type can quickly lead to “information overload” and significantly impact an agent's ability to deliver quality service. An agent's attention is a valuable resource, and any advancement that limits the information that an agent must process during their daily work is likely to provide outsized benefits in terms of performance over the length of an agent's working shift.

To alleviate the above problem, the present invention includes the addition of what will be referred to herein as a “conversation analyzer” to the knowledge management system. In accordance with exemplary embodiments, the conversation analyzer provides an initial analysis to each successive new set of turns to determine if it should be sent to the knowledge search system for being formulated as a query. As will be seen, this functionality enables the conversation analyzer to significantly reduce the computational load on the knowledge search system as well as the cognitive load on the agent.

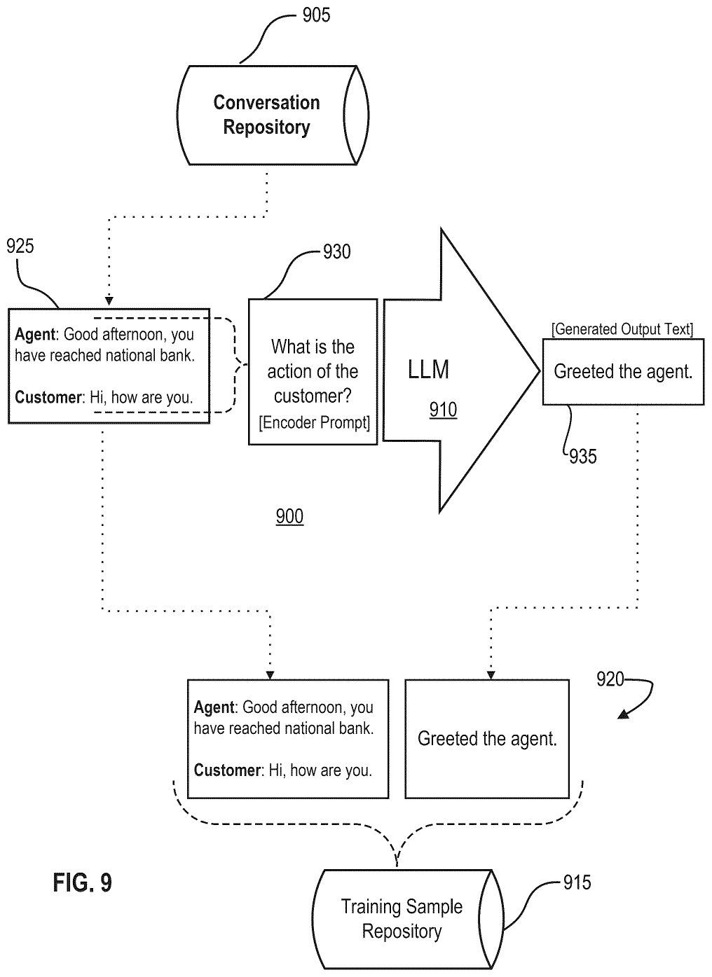

With reference now to FIG. 9, an exemplary system 900 is shown for efficiently generating training samples that can then be used to train a model for performing the functionality of the conversation analyzer. The system 900 may include a conversation repository 905 that stores text data drawn form large numbers of customer-agent conversations. The system 900 may further include a foundational large language model (LLM) 910. Finally, the system 900 may include a training sample repository 915 that stores each generated training sample 920.

In accordance with exemplary embodiments, the system 900 may create training samples in the following way. First, one or more conversational turns are selected from the conversations stored in the conversation repository 915. As used herein, the one or more conversational turns may be referred to as a “set of turns” or, simply, a “turn set”. As stated, a “turn” refers to a turn of speaking within a conversation by one of the participants. The turns that occurring within a conversation can also be classified by speaker, with, for example, an “agent turn” being a turn in which the agent is speaking and a “customer turn” being a turn in which the customer is speaking. In certain embodiments, a turn set may be a single turn. In other embodiments, a turn set is a couple of turns, which may be referred to as a “pair or turns” or “turn pair”. In some cases, a turn set may include three or more turns. When a turn set includes a plurality of turns, the plurality of turns within the set may occur consecutively in the conversation. For the sake of simplicity, the turn set used in the example of FIG. 9 is a pair of turns or turn pair. As used herein, such a turn pair may include two consecutively occurring turns from a given conversation that includes both an agent turn and a customer turn. In the example shown, the first selected turn pair 925 is the initial turn pair in the conversation that was introduced in FIG. 8.

In accordance with exemplary embodiments, the selected turn pair 925 is then provided as an input to the foundational LLM model 910, as indicated in FIG. 9. Along with the selected turn pair 925, a particular encoder prompt 930 is also provided as an input. The encoder prompt 930 also may be referred to as a question prompt. As shown, the encoder prompt 930 may ask “What is the action of the customer?” or “What action is taken by the customer?”

In exemplary embodiments, the foundational LLM 910 is a type of artificial intelligence (AI) algorithm that uses deep learning techniques and massively large data sets to understand, summarize, generate, and predict new content. The foundational LLM 910 may be a large language model that is trained to take in text as an input and produce text as an output. Preferably, the foundational LLM 910 is trained and finetuned on specifical question answering and summarization style of text-to-text. In accordance with certain embodiments, the foundational LLM 910 of the present invention is a large language model having at least 1 billion parameters. Alternatively, the foundational LLM 910 has at least 3 billion parameters. In other cases, the LLM of the present invention has at least 7 billion parameters. The foundational LLM 910 of the present invention may be constructed using the known transformer architecture, as either a decoder-only or encoder-decoder. The foundational LLM 910 may be trained using unsupervised data scrapped from the internet, with the objective of predicting the next word given all previous words in the context. The unsupervised data, for example, may be gathered from a wide range of sources, such as, Reddit chats, Wikipedia articles, books, etc. Such language models may have a limited context window, for example, 2048 tokens. If the text exceeds this limit, then only the last 2048 tokens are considered by the neural network model. For example, an LLM used as the foundational LLM 910 may be a TO++ (or TOPP) model. The TOPP model is an open source encoder-decoder LLM with a neural network having over eleven billion parameters. Other exemplary LLMs that could be used as part of the functioning of the present invention include other open source models as well as closed models. Llama 2 (a decoder-only model developed by Meta/Facebook), BTLM (developed by Cerebras), Pythia (developed by EleutherAI), and MPT (developed by Mosaiclm). Each of these models has between 1-7 billion parameters. In accordance with exemplary embodiments, the process of the present invention may include using an open source model, such as those identified, that is then further trained or finetuned on contact center data, for example, text from agent-customer interactions. Such LLMs can be trained pursuant to contact center data derived from within particular industries, companies, or other particularly defined contexts. Some examples of closed models that can be used with the present invention include GPT-3.5/4 (developed by OpenAI/Microsoft Azure), Claude (developed by Anthropic through Amazon Bedrock). While such closed models typically cannot be further trained on a developer's own data, such models can be trained or finetuned on quantities of synthetic data that is provided by the model's developer. Other similar LLMs to those discussed above may also be used.

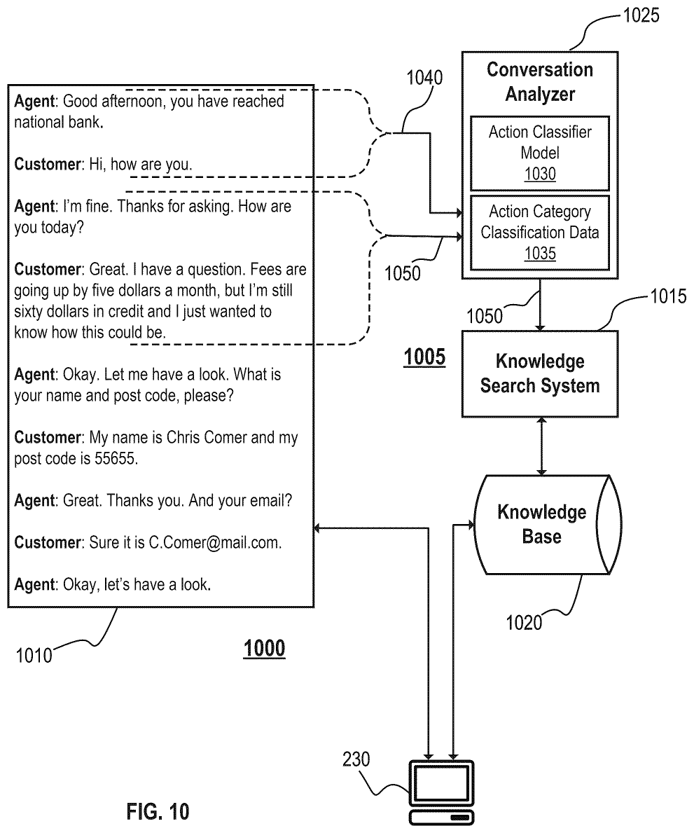

Continuing with the discussion as to operation related to FIG. 10, the turn pair 925 is fed as an input to the foundational LLM 910 along with the encoder prompt 930 so to cause the foundational LLM 910 to generate a response. The foundational LLM 910 then generates output text 935 based on the given inputs. This output may also be referred to as an insight. To do this, the foundational LLM 910 answers the question posed by the encoder prompt 930 given the content of the selected turn pair 925. In the example shown, the answer or output text 935 generated is “greeted the agent”, which, as will be appreciated, accurately describes the action taken by the customer in the selected turn pair 925. The output text 935 generated by the foundational LLM 910 is then stored in association with the turn pair 925 to create a training sample 920. For example, each generated training sample 920 may be stored in the training sample repository 915. The process is then repeated in relation to another turn pair selected from the conversation repository 905. This results in the generation of another training sample. This continues until a sufficient number of training samples are generated.

In generating the training samples, many different categories or types of customer actions (or action categories) will become evident. For example, such action categories may include: greeted the agent; asked for help; provided policy details; thanked the agent; confirmed agent response; said goodbye to agent; etc. Within these action categories, an operator can select those categories for which a knowledge base search is desirable or needed and those for which a knowledge base search is not desirable or needed. For example, turn pairs having a customer action that involves a greeting or saying goodbye could be easily categorized by the operator as not needing a knowledge search. However, if the action involves the customer asking for help, the operator will easily know that it should be classified as being an action category for which a knowledge search is needed. Such classifications of the action categories can be recorded and saved as action category classification data, as discussed more in relation to FIG. 10.

Alternatively, in accordance with alternative embodiments, the conversation repository may include further data that records or identifies conversation turns that generated knowledge base queries that were successful. Such data may further identify conversation turns that generated knowledge base queries that were unsuccessful. As an example, such data may be gathered via monitoring operational results associated with the conventional knowledge management system of FIG. 8. For example, data may be recorded identifying each turn pair that produces a search query that resulted in the retrieval of a knowledge base article that the agent found useful in the interaction (i.e., used during an interaction, shared with a customer, etc.). Data may also be recorded that identifies those turn pairs that did not produce a useful search query. With this additional information, it may not be required to have an operator to select those action categories for which search queries are needed. Instead, the process can be automated pursuant to a calculable metric regarding a percentage of useful search queries produced by the turn pairs included within a given action category. Thus, any action category that does not produce a percentage of useful search queries above a certain threshold can be automatically classified as being one that does not need a knowledge base search. For an action category that exceeds the threshold, it may be classified as being one that needs a knowledge base search.

In accordance with preferred embodiments, a smaller model—which may be referred to herein as an customer action classifier model or, simply, “action classifier model”—is trained pursuant to the generated training samples. Model distillation techniques may also be employed. The action classifier model is a model that is sized so that it may be run efficiently during live operations of the contact center. As will be seen, the action classifier model will classify customer actions based on an input of a turn set (for example, a turn pair) derived from ongoing conversations occurring in live interactions. In certain embodiments, the action classifier model comprises a machine learning model configured as a sequence-to-sequence model (or “seq2seq model”). A seq2seq model is composed of an encoder and decoder that are typically implemented as RNNs. The encoder captures the context of the input sequence and sends it to the decoder, which then produces the final output sequence. The encoder is responsible for processing the input sequence and capturing its essential information, which is stored as the hidden state of the network and, in a model with attention mechanism, a context vector. The context vector is the weighted sum of the input hidden states and is generated for every time instance in the output sequences. The decoder takes the context vector and hidden states from the encoder and generates the final output sequence. The decoder operates in an autoregressive manner, producing one element of the output sequence at a time. At each step, it considers the previously generated elements, the context vector, and the input sequence information to make predictions for the next element in the output sequence. Specifically, in a model with attention mechanism, the context vector and the hidden state are concatenated together to form an attention hidden vector, which is used as an input for the decoder. In other embodiments, the action classifier model comprises transformer architecture in accordance with the characteristics described above.

The training of the action classifier model will proceed in accordance with the accumulated training samples. The training may occur per the discussion above in relation to FIG. 7 for machine learning models. For example, when described in relation to a given first one of the training sample (“first training sample”) in the training dataset, which is representative of how each of the training samples in the training dataset are used to train the machine learning model, the training of the machine learning model (i.e., the action classifier model) may include: providing as input to the machine learning model the turn pair of the first training sample; generating as output of the machine learning model a predicted customer action given the input; comparing the actual customer action for the first training sample to the predicted customer action and, via the comparison, determining a difference therebetween; and adjusting parameters of the machine learning model to reduce the determined difference. This training process continues until the action classifier model mimics the predictions of the foundational LLM to within an acceptable threshold. Alternatively, the foundational LLM could be used in place of the smaller action classifier model with live conversations. However, this may not be possible to scale with the number of concurrent interactions handled by the contact center and/or otherwise be computationally inefficient.

With reference now to FIG. 10, a system 1000 is shown that includes a knowledge management system 1005 in accordance with the present invention. As indicated, the agent is conducting an ongoing conversation with a customer, which is represented by conversation text 1010. The knowledge management system 1005 includes a knowledge search system 1015 and knowledge base 1020. In this case, the knowledge management system 1005 is augmented by a conversation analyzer 1025, which includes a trained action classifier model 1030 (as described above) and action category classification data (or simply “classification data”) 1035. As the conversation occurs, each successive turn set—which may be a single turn, a turn pair, etc.—is sent first to the conversation analyzer 1025. Within the conversation analyzer, the turn pair is provided as an input to the action classifier model along with an encoder prompt for generating an output. The output generated by the action classifier model 1030 is the action of the customer given the turn pair, as predicted by the action classifier model 1030. Thus, for example, the output of the action classifier model 1030 may include a statement describing the action of the customer, such as “greeted the agent” or “asked for help”. The output action of the action classifier model 1030 is then compared against the classification data 1035 to determine if the turn pair should be passed along to the knowledge search system 1015. Specifically, the classification data 1035 identifies those categories of actions for which it is deemed desirable or needed to pass to the knowledge search system 1015/knowledge base 1020. As described earlier, such classifications can be provided by an operator or determined via an automated process.

In the example depicted in FIG. 10, one or more conversational turns are sent to the conversation analyzer 1025. As described, the one or more conversational turns may be referred to as a “turn set”. In certain embodiments, a turn set may be a single turn. In other embodiments, a turn set is a turn pair or include more turns. In certain embodiments, turn sets may be defined on a rolling basis. For example, defined as the latest turn plus a predetermined number of turns that occurred just prior to the latest turn. For the sake of simplicity, the turn set used in the example of FIG. 10 is a turn pair.

The initial turn pair 1040 is transmitted to the conversation analyzer 1025. The action classifier model 1030 then predicts the customer action, which is “greeted the agent”. This predicted customer action is compared to the action category classification data 1035. Because the “greeted the agent” action category is not one that would be selected as needing a knowledge base search, the initial turn pair 1040 is not one that is passed to the knowledge search system 1015. That is, functionality of the present invention suppresses or prohibits the initial turn pair 1040 from being passed along to the knowledge search system 1015, as the category of customer action is one that is marked as “knowledge search not needed”. The next turn pair 1050 then arrives at the conversation analyzer 1025, and the same process is performed in relation to it. In this case, the action predicted by the action classifier model 1030 would be one indicating that the customer is asking for help. Comparison of this customer action to the classification data 1035 finds that this action category is one marked “knowledge search needed”. Because of this, the turn pair 1050, as indicated, is passed along to the knowledge search system 1015 for initiating a search query. A search query is then formulated that is then posed to the knowledge base 1020 for retrieving relative information or documents therefrom. Using the formulated search query, a determination is then made whether the knowledge base 1020 has relevant documents and/or whether any relevant documents should be retrieved and presented to the agent. For example, the retrieved document may be analyzed in regard to a relevance to language used in the turns and, if the analysis results in a relevancy that exceeds some predefined threshold, the search results, i.e., the retrieved document, is presented to agent. In doing this, the retrieved document may be shown to the agent via a display window that is incorporated into a user interface of an agent device 230. The process continues in real time in relation to subsequent turn pairs.

In an alternative embodiment, the determination as to which action category a customer action falls within is made through comparing semantic meaning. In this way, the process is able to handle customer actions that are newly encountered or, at least, phrased in a new way as long as they are semantically similar to customer actions that have already been categorized. In such embodiments, the customer actions within the action categories may be transformed into a vector embedding, with the vector embedding then being stored as part of the classification data. As will be appreciated, in natural language processing (NLP), a vector embedding (which also may be referred to simply as a embedding or vector) is a representation of a word or phrase or sentence. Typically, the representation is a real valued vector that encodes the meaning of the word in such a way that words that are closer in the vector space are expected to be similar in meaning. Such embeddings can be obtained using language modeling and feature learning techniques, where words or phrases from the vocabulary are mapped to vectors of real numbers. This functionality may be achieved via the use of a sentence transformer, such as a neural network sentence transformer, that is configured to take the insight as an input and generate a representative vector embedding in relation thereto. In exemplary embodiments, the sentence transformer may be an embeddings language model. An embeddings language-model is specialized in taking a phrase or sentence as an input and computing a representative vector embedding, with the objective being to capture inside the computed vector embedding the semantic meaning of the sentence. Such neural network language models may be trained, for example, on via contrastive learning where the training data includes a triplet of sentences with two being tagged as being similar and one tagged as being not similar. As an example, an embedding language model such as MPNet may be employed in this step of the process. Other similar models may also be used for this step in the process. Accordingly, in exemplary embodiments, the sentence transformer of the present invention may be a package of pretrained neural networks that is configured to encode phrases or sentences (i.e., a customer action) into an embedding (vector of numbers of some large size, e.g., 1024). As will be appreciated, once encoded, such vectors have the property that semantically similar sentences produce vectors that have high cosine similarity (dot product), while semantically dissimilar have low cosine similarity score. With the vector embedding generated, the vector embeddings may be stored in an index that enables efficient searching. As an example, an open source system such as Faiss may be used to do this. In such an indexing system, the vector embeddings are indexed so that the stored vectors most similar to a submitted query vector can be quickly identified. The index may also associate the stored vector embedding with the interaction from which it was derived so that other data stored in association with the interaction may be recalled as needed.

The vector embeddings of the customer actions may be indexed within the action categories that are defined by the classification data. Such action categories may include: a first action category, which includes a first plurality of the customer actions found in the training samples for which a knowledge base search is deemed needed, and a second action category, with includes a second plurality of the customer actions found in the training samples for which a knowledge base search is deemed not needed. The categorized vector embeddings for both categories may then be used to determine whether a customer action found by the action classifier model to be in a present turn set of an ongoing conversation should be used to initiate a knowledge base search. To do this, the customer action found in the present turn set is first transformed via a sentence transformer into a vector embedding. As before, the sentence transformer may be an embeddings language-model configured to transform the text of the search request by computing a vector embedding representative of a semantic meaning of the text of a given customer action. Then a determination is made as to whether a matching customer action appears in the first plurality of the customer actions of the first action category or the second plurality of the customer actions of the second action category. In accordance with exemplary embodiments, this may be done by comparing the vector embedding of the customer action of the present turn set against the vector embeddings of the customer actions found in both the first plurality of customer actions and the second plurality of customer actions. The matching customer action is determined to be the one of the customer actions in either the first plurality of customer actions or the second plurality of customer actions that the comparison reveals to have a most similar semantic meaning to the customer action of the present turn set. A computed similarity between the vector embedding of the present customer action and that of the vector embedding of the matching customer action may also be required to have a similarity computed as being above a predetermined similarity threshold. As an example, cosine similarity may be used to compute similarity. This embodiment enables functionality where exact textual matches for customer actions are not required, as matches between customer actions may also be found for those having sufficiently similar semantic meaning.

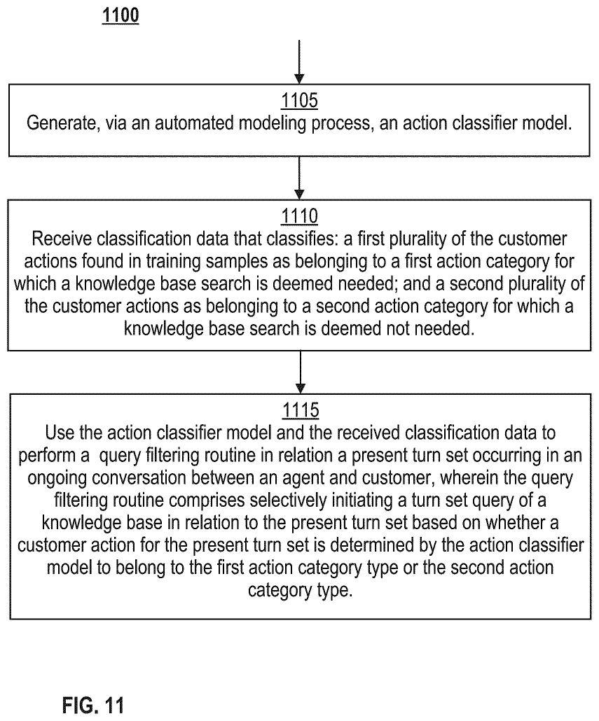

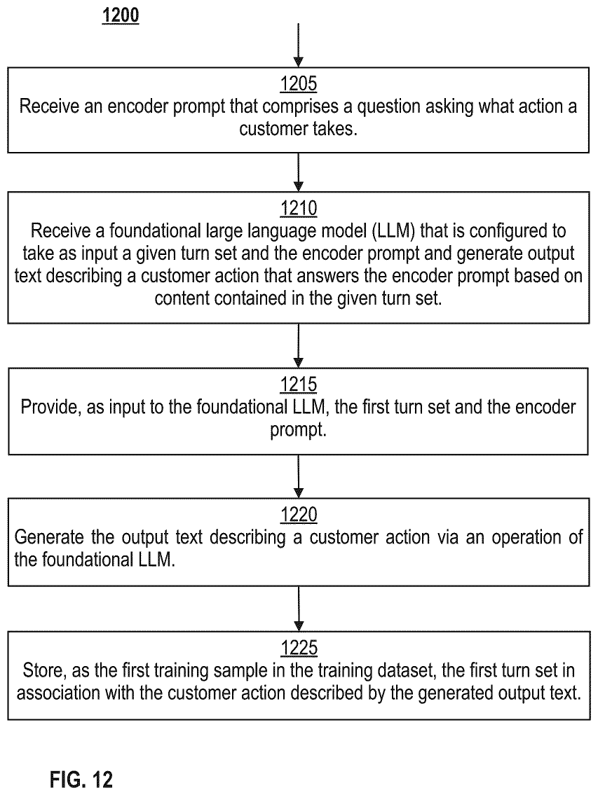

With reference now to FIG. 11, an exemplary method 1100 is shown that illustrates an embodiment of the present invention. As already described, the method 1100 may be used by a contact center for generating an action classifier model and use thereof in selectively initiating turn set queries of a knowledge base to assist agents in real time during ongoing conversations with customers. The method 1100 begins, at step 1105, by generating, via an automated modeling process, an action classifier model. Further aspects of the automated modeling process will be discussed in relation to FIG. 12.

At step 1110, the method 1100 continues by receiving classification data that classifies: a first plurality of the customer actions found in training samples as belonging to a first action category for which a knowledge base search is deemed needed; and a second plurality of the customer actions as belonging to a second action category for which a knowledge base search is deemed not needed.

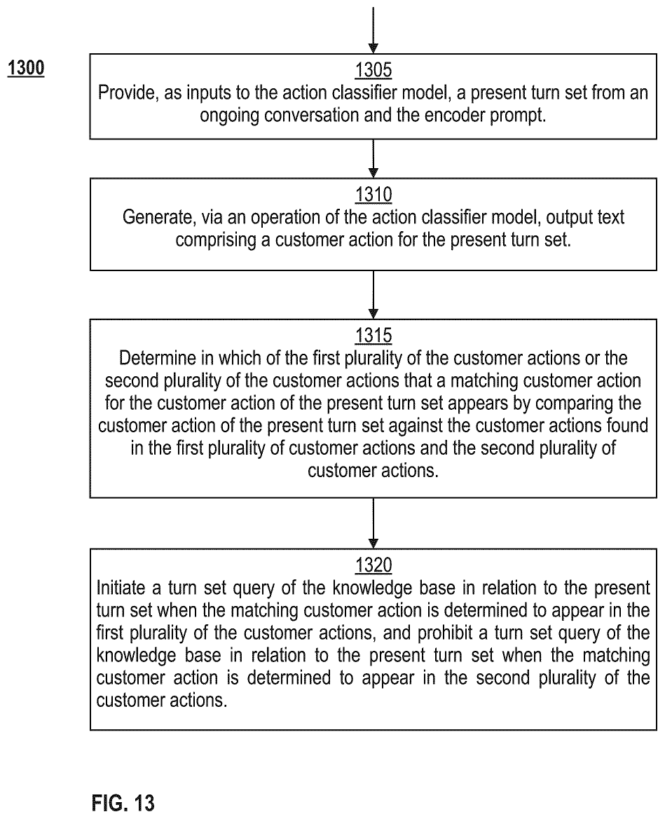

At step 1115, the method 1100 continues by using the action classifier model and the received classification data to perform a query filtering routine in relation to a present turn set occurring in an ongoing conversation between an agent and customer. The query filtering routine may include selectively initiating a turn set query of a knowledge base in relation to the present turn set based on whether a customer action for the present turn set is determined by the action classifier model to belong to the first action category type or the second action category type. Further aspects of the query filtering routine will be discussed in relation to FIG. 13.

With reference now to FIG. 12, further aspects will be discussed as to how the action classifier model is generated via the automated modeling process. Within this process, the method 1200 may be used to create a training dataset by generating training samples in relation to respective turn sets selected from stored conversation data related to previous conversations. When described in relation to an exemplary first turn set from which a first training sample is generated, each training sample may be created via the following steps of method 1200.

The method 1200 begins, at step 1205, by receiving an encoder prompt that comprises a question asking what action a customer takes. At step 1210, the method 1200 continues by receiving a foundational large language model (LLM) that is configured to take as input a given turn set and the encoder prompt and generate output text describing a customer action that answers the encoder prompt based on content contained in the given turn set. At step 1215, the method 1200 continues by providing, as input to the foundational LLM, the first turn set and the encoder prompt. At step 1220, the method 1200 continues by generating the output text describing a customer action via an operation of the foundational LLM. At step 1225, the method 1200 continues by storing, as the first training sample in the training dataset, the first turn set in association with the customer action described by the generated output text.

The action classifier model may then be trained on the generated training samples within the training dataset. The action classifier model is trained via a machine learning algorithm until the action classifier model predicted customer actions from the respective turn sets found in the training samples mimics the actual customer actions of the foundational LLM to within an acceptable threshold. For example, when described in relation to the first training sample in the training dataset, which is representative of how each of the training samples in the training dataset are used to train the action classifier model, the training the action classifier model may include: providing, as input to the action classifier model, the first turn set and the encoder prompt; generating output text describing a predicted customer action via an operation of the action classifier model; comparing an actual customer action of the first training sample to the predictive customer action and, via the comparison, determining a difference therebetween; and adjusting parameters of the action classifier model to reduce the determined difference.

With reference now to FIG. 13, an exemplary method 1300 is shown for performing a query filtering routine with the action classifier model according to the present invention. As will be appreciated, the query filtering routine may be performed repeatedly in relation to respective successively occurring turn sets derived in real time from the ongoing conversation. In a preferred embodiment, the turn set is a turn pair, which is a turn set having two consecutively occurring conversational turns in which one of the turns is an conversational turn of the agent and the other of the turns is a conversational turn of the customer. The method 1300 begins, at step 1305, by providing, as inputs to the action classifier model, a present turn set from an ongoing conversation and the encoder prompt. At step 1310, the method 1300 continues by generating via an operation of the action classifier model, output text comprising a customer action for the present turn set. At step 1315, the method 1300 continues by determining in which of the first plurality of the customer actions or the second plurality of the customer actions that a matching customer action for the customer action of the present turn set appears by comparing the customer action of the present turn set against the customer actions found in the first plurality of customer actions and the second plurality of customer actions. The matching customer action may comprise the customer action in either the first plurality of customer actions or the second plurality of customer actions revealed by the comparison to have an output text that matches the output text of the customer action of the present turn set. At step 1320, the method 1300 continues by initiating a turn set query of the knowledge base in relation to the present turn set when the matching customer action is determined to appear in the first plurality of the customer actions, and prohibit a turn set query of the knowledge base in relation to the present turn set when the matching customer action is determined to appear in the second plurality of the customer actions.

In an alternative embodiment, the query filtering routing may determine the matching customer action by comparing vector embeddings. In such embodiments, a sentence transformer comprising an embeddings language-model may be used to generate vector embeddings for each of the customer actions found in the first and second plurality of customer actions. With this complete, the query filtering routine may further comprise the steps of: providing, as inputs to the action classifier model, the present turn set and the encoder prompt; generating, via an operation of the action classifier model, output text comprising a customer action for the present turn set; generating, via the sentence transformer comprising the embeddings language-model, a vector embedding for the customer action of the present turn set; and determining in which of the first plurality of the customer actions or the second plurality of the customer actions that a matching customer action for the customer action of the present turn set appears by comparing vector embeddings. Specifically, the vector embedding of the customer action of the present turn set may be compared against the vector embeddings of the customer actions found in both the first plurality of customer actions and the second plurality of customer actions. The matching customer action may be the customer actions in either the first plurality of customer actions or the second plurality of customer actions revealed by the comparison to have a most similar semantic meaning to the customer action of the present turn set. The query filtering routine may continue by initiating a turn set query of the knowledge base in relation to the present turn set when the matching customer action is determined to appear in the first plurality of the customer actions, or prohibiting a turn set query of the knowledge base in relation to the present turn set when the matching customer action is determined to appear in the second plurality of the customer actions. As an example, a computed cosine similarity may be used to compare the vector embedding of the customer action of the present turn set against the vector embeddings of the customer actions found in both the first and second plurality of customer actions. In exemplary embodiments, the embeddings language-model of the sentence transformer comprises a pretrained neural networks configured to encode sentences into embedding vectors such that, once encoded, the embedding vectors of semantically similar sentences comprise a cosine similarity that is greater than a cosine similarity of the embedding vectors from semantically dissimilar sentences.

In certain embodiments, both the previous conversations and the ongoing conversation may each be live voice conversations (i.e., conducted via a voice channel). In such cases the method may further include the step of first transcribing via automatic speech recognition the previous conversations and the ongoing conversation.

In alternative embodiments, the classification data may be derived in different ways. In one embodiment, for example, the classification data is received via user input. In such cases, the method may further include the steps of: generating a user interface on a display that lists the customer actions found in the training samples and facilitates a human operator to provide input selecting customer actions of the listed customer actions for inclusion in the first action category and the second action category; and receiving input from the human operator classifying the first plurality of the customer actions as belonging to the first action category and the second plurality of the customer actions as belonging to the second action category.

In an alternative embodiment, the classification data is generated via an automated process. The automated process may being by recording, in relation to each of the turn sets from the previous conversations, search outcome data reflecting whether the turn set generated a successful knowledge base search, which is defined as a knowledge base search based on the given turn set that returns a knowledge base article used by the agent to assist the customer, or an unsuccessful knowledge base search, which is defined as a knowledge base search based on the given turn set that did not return a knowledge base article used by the agent to assist the customer. As a next step, the customer actions in the training samples may be sorted into same customer action sets (i.e., the turn set having the same customer action along with the search outcome data). For each of the same customer action sets, a percentage may then be calculated in relation to how many of the turn sets with each resulted in a successful knowledge base search out of the total number included within the given same customer action set. From there, classification may be based on whether the percentage satisfies a predetermined threshold. Thus, the customer action (i.e., the same customer action) of each of the same customer action sets calculated as having a percentage that satisfies the predetermined threshold may be classified as belonging to the first action category for which the knowledge base search is deemed needed, while the customer action (i.e., the same customer action) of each of the same customer action sets calculated as having a percentage that does not satisfy the predetermined threshold may be classified as belonging to the second action category for which the knowledge base search is deemed not needed.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A computer-implemented method in a contact center for generating an action classifier model and use thereof in selectively initiating turn set queries of a knowledge base to assist agents in real time during ongoing conversations with customers, wherein the method comprises the steps of:
generating, via an automated modeling process, an action classifier model, wherein the automated modeling process comprises:
creating a training dataset by generating training samples in relation to respective turn sets selected from stored conversation data related to previous conversations, wherein, when described in relation to an exemplary first turn set from which a first training sample is generated, each training sample is created by:
receiving an encoder prompt that comprises a question asking what action a customer takes;
receiving a foundational large language model (LLM) that is configured to take as input a given turn set and the encoder prompt and generate output text describing a customer action that answers the encoder prompt based on content contained in the given turn set;
providing, as input to the foundational LLM, the first turn set and the encoder prompt;
generating the output text describing a customer action via an operation of the foundational LLM;
storing, as the first training sample in the training dataset, the first turn set in association with the customer action described by the generated output text;
training the action classifier model on the training samples of the training dataset;
receiving classification data that classifies:
a first plurality of the customer actions found in the training samples as belonging to a first action category for which a knowledge base search is deemed needed; and
a second plurality of the customer actions as belonging to a second action category for which a knowledge base search is deemed not needed;
using the trained action classifier model and the received classification data to perform a query filtering routine in relation a present turn set occurring in an ongoing conversation between an agent and customer, wherein the query filtering routine comprises selectively initiating a turn set query of a knowledge base in relation to the present turn set based on whether a customer action for the present turn set is determined by the action classifier model to belong to the first action category type or the second action category type.

2. The method of claim 1, wherein the query filtering routine further comprises:
providing, as inputs to the action classifier model, the present turn set and the encoder prompt;
generating, via an operation of the action classifier model, output text comprising a customer action for the present turn set; and
determining in which of the first plurality of the customer actions or the second plurality of the customer actions that a matching customer action for the customer action of the present turn set appears by:
comparing the customer action of the present turn set against the customer actions found in the first plurality of customer actions and the second plurality of customer actions, the matching customer action comprising a one of the customer actions in either the first plurality of customer actions or the second plurality of customer actions revealed by the comparison to have an output text that matches the output text of the customer action of the present turn set.

3. The method of claim 2, wherein the query filtering routine further comprises:
initiating a turn set query of the knowledge base in relation to the present turn set when the matching customer action is determined to appear in the first plurality of the customer actions; and
prohibiting a turn set query of the knowledge base in relation to the present turn set when the matching customer action is determined to appear in the second plurality of the customer actions.

4. The method of claim 1, further comprising the steps of:
generating, via a sentence transformer comprising an embeddings language-model, vector embeddings for each of the customer actions found in the first and second plurality of customer actions;
wherein the query filtering routine further comprises:
providing, as inputs to the action classifier model, the present turn set and the encoder prompt;
generating, via an operation of the action classifier model, output text comprising a customer action for the present turn set;
generating, via the sentence transformer comprising the embeddings language-model, a vector embedding for the customer action of the present turn set; and
determining in which of the first plurality of the customer actions or the second plurality of the customer actions that a matching customer action for the customer action of the present turn set appears by:
comparing the vector embedding of the customer action of the present turn set against the vector embeddings of the customer actions found in both the first plurality of customer actions and the second plurality of customer actions, the matching customer action comprising a one of the customer actions in either the first plurality of customer actions or the second plurality of customer actions revealed by the comparison to have a most similar semantic meaning to the customer action of the present turn set.

5. The method of claim 4, wherein the query filtering routine further comprises:
initiating a turn set query of the knowledge base in relation to the present turn set when the matching customer action is determined to appear in the first plurality of the customer actions; and
prohibiting a turn set query of the knowledge base in relation to the present turn set when the matching customer action is determined to appear in the second plurality of the customer actions.

6. The method of claim 5, wherein the vector embedding of the customer action of the present turn set are compared against the vector embeddings of the customer actions found in both the first plurality of customer actions and the second plurality of customer actions via a computed cosine similarity.

7. The method of claim 6, wherein the embeddings language-model of the sentence transformer comprises a pretrained neural networks configured to encode sentences into embedding vectors such that, once encoded, the embedding vectors of semantically similar sentences comprise a cosine similarity that is greater than a cosine similarity of the embedding vectors from semantically dissimilar sentences.

8. The method of claim 3, wherein the query filtering routine is performed repeatedly in relation to respective successively occurring turn sets derived in real time from the ongoing conversation.

9. The method of claim 3, wherein the turn set is defined as a turn pair having two consecutively occurring conversational turns in which a first turn is an conversational turn of the agent and a second turn is a conversational turn of the customer.

10. The method of claim 3, wherein the foundational LLM comprises a neural network model having at least 1 billion parameters that is configured to take in text as an input and produce text as an output.

11. The method of claim 3, wherein the foundational LLM comprises a neural network model having at least 3 billion parameters that is configured to take in text as an input and produce text as an output.

12. The method of claim 3, wherein the action classifier model comprises a machine learning model configured as a sequence-to-sequence model.

13. The method of claim 12, wherein the action classifier model is trained via a machine learning algorithm until the action classifier model outputs predicted customer actions from the respective turn sets found in the training samples that mimic the actual customer actions output by the foundational LLM to within an acceptable threshold.

14. The method of claim 13, wherein, when described in relation to the first training sample in the training dataset, which is representative of how each of the training samples in the training dataset are used to train the action classifier model, the step of training the action classifier model comprises:
providing, as input to the action classifier model, the first turn set and the encoder prompt;
generating output text describing a predicted customer action via an operation of the action classifier model;
comparing an actual customer action of the first training sample to the predictive customer action and, via the comparison, determining a difference therebetween; and
adjusting parameters of the action classifier model to reduce the determined difference.

15. The method of claim 3, wherein the previous conversations and the ongoing conversation each comprise conversations conducted via a voice channel;
further comprising the step of transcribing via automatic speech recognition the previous conversations and the ongoing conversation.

16. The method of claim 3, wherein the step of receiving classification data comprises:
generating a user interface on a display that lists the customer actions found in the training samples and facilitates a human operator to provide input selecting customer actions of the listed customer actions for inclusion in the first action category and the second action category; and
receiving input from the human operator classifying the first plurality of the customer actions as belonging to the first action category and the second plurality of the customer actions as belonging to the second action category.

17. The method of claim 3, further comprising the step of generating the classification data by:
recording, in relation to each of the turn sets of the stored conversation data related to previous conversations, search outcome data regarding whether a given turn set generated a successful knowledge base search, which is defined as a knowledge base search based on the given turn set that returns a knowledge base article used by the agent to assist the customer, or an unsuccessful knowledge base search, which is defined as a knowledge base search based on the given turn set that did not return a knowledge base article used by the agent to assist the customer;
sorting the customer actions in the training samples into same customer action sets, wherein each of the same customer action sets comprises the turn sets that resulted in a same customer action and the respective associated search outcome data;
calculating, for each of the same customer action sets, a percentage of the turn sets within a given same customer action set that generated a successful knowledge base search; and
classifying:
the customers action of each of the same customer action sets calculated as having a percentage that satisfies a predetermined threshold as belonging to the first action category for which the knowledge base search is deemed needed; and
the customers action of each of the same customer action sets calculated as having a percentage that does not satisfy the predetermined threshold as belonging to the second action category for which the knowledge base search is deemed not needed.

18. A system in a contact center for generating an action classifier model and use thereof in selectively initiating turn set queries of a knowledge base to assist agents in real time during ongoing conversations with customers, the system comprising:
a processor; and
a memory storing instructions which, when executed by the processor, cause the processor to perform the steps of:
generating, via an automated modeling process, an action classifier model, wherein the automated modeling process comprises:
creating a training dataset by generating training samples in relation to respective turn sets selected from stored conversation data related to previous conversations, wherein, when described in relation to an exemplary first turn set from which a first training sample is generated, each training sample is created by:
receiving an encoder prompt that comprises a question asking what action a customer takes;
receiving a foundational large language model (LLM) that is configured to take as input a given turn set and the encoder prompt and generate output text describing a customer action that answers the encoder prompt based on content contained in the given turn set;
providing, as input to the foundational LLM, the first turn set and the encoder prompt;
generating the output text describing a customer action via an operation of the foundational LLM;
storing, as the first training sample in the training dataset, the first turn set in association with the customer action described by the generated output text;
training the action classifier model on the training samples of the training dataset;
receiving classification data that classifies:
a first plurality of the customer actions found in the training samples as belonging to a first action category for which a knowledge base search is deemed needed; and
a second plurality of the customer actions as belonging to a second action category for which a knowledge base search is deemed not needed;
using the trained action classifier model and the received classification data to perform a query filtering routine in relation a present turn set occurring in an ongoing conversation between an agent and customer, wherein the query filtering routine comprises selectively initiating a turn set query of a knowledge base in relation to the present turn set based on whether a customer action for the present turn set is determined by the action classifier model to belong to the first action category type or the second action category type.

19. The system of claim 18, wherein the query filtering routine further comprises:
providing, as inputs to the action classifier model, the present turn set and the encoder prompt;
generating, via an operation of the action classifier model, output text comprising a customer action for the present turn set; and
determining in which of the first plurality of the customer actions or the second plurality of the customer actions that a matching customer action for the customer action of the present turn set appears by:
comparing the customer action of the present turn set against the customer actions found in the first plurality of customer actions and the second plurality of customer actions, the matching customer action comprising a one of the customer actions in either the first plurality of customer actions or the second plurality of customer actions revealed by the comparison to have an output text that matches the output text of the customer action of the present turn set.

20. The system of claim 19, wherein the query filtering routine further comprises:
initiating a turn set query of the knowledge base in relation to the present turn set when the matching customer action is determined to appear in the first plurality of the customer actions; and
prohibiting a turn set query of the knowledge base in relation to the present turn set when the matching customer action is determined to appear in the second plurality of the customer actions.
